(19) United States
(12) Patent Application Publication
(10) Pub. No.: US 2017/0012413 A1
(43) Pub. Date: Jan. 12, 2017

(54) INSPECTION ROBOT FOR LIVE TRANSMISSION LINE CABLES

(71) Applicants: Light Serviços de Eletricidade S/A, Rio de Janeiro (BR); Fundação CPQD - Centro de Pesquisa e Desenvolvimen em Telecomunicações, Campinas (BR)

(72) Inventors: Célio Fonseca Barbosa, Campinas (BR); Raphael Nunes de Souza, Campinas (BR); Flávio Eduardo Nallin, Campinas (BR); José Benedito Costa Araujo, Pechincha - Rio de Janeiro (BR); Haroldo Sant'Anna da Silva, Paracambi (BR); Marcio Luiz Lima Penna, Paracambi (BR)

(21) Appl. No.: 14/796,761

(22) Filed: Jul. 10, 2015

(51) Int. Cl. H02G 1/02

(52) U.S. Cl. CPC H02G 1/02

(57) ABSTRACT

This invention addresses an inspection robot for live transmission line cables that is comprised of a pair of guide rollers located on each side of the robot in order to guide the conductor into its position alongside the pulleys that support its weight and ensure its movement; a worm thread axis and springs that press the guide rollers against the conductor; where the gap between the guide rollers is adjusted previously through a disc that triggers a worm thread mechanism, in order to size its opening to the gauge of the conductor that will be inspected; and a mechanism coupled to the hoisting eyebolt whereby when this eyebolt is pulled, the sensor opens to receive the conductor and when the robot is supported by the conductor and the eyebolt is loosened, a spring forces the sensor into its closed position.

### FIELD OF THE INVENTION

This invention addresses inspection robots for live transmission line cables in general, and in particular inspection robots for live transmission line cables that could be installed using an insulating rod.

### BACKGROUND OF THE INVENTION

Power lines consist of conducting cables that carry electrical current. These cables are subject to the effects of weathering, such as corrosion of their elements, cracks caused by wind vibration and damage due to atmospheric discharges [lightning bolts]. As these cables are normally live and installed at great heights, it is hard for the concessionaire electrician to access them for the purposes of inspection or even repair. It must be noted that such inspections are necessary in order to avoid the cable breaking, with consequences that could be very serious, such as power outages for large segments of the population and/or accidents involving vehicles and people, should the cable fall onto a highway or in an inhabited area.

Consequently, the need arises for a tele-controlled robot that could be installed on the conductor and inspect it. An initial device was developed by the authors of this invention, whose main innovative aspects were claimed through an application for a patent of invention filed with the INPI on Aug. 6, 2007 [1]. However, in order to install this device, the power line cannot be live. This constitutes a constraint on the use thereof, as planning is required for tasks involving several agents, due to the need to switch off the line that will be inspected. In order to overcome this flaw, a new device was developed that operates when the line is live. However, a difficulty arose over how to install the robot on the conductor, when it is live at high voltages.

Several possible alternatives encompass those normally used for working on live power lines, such as accessing the conductor by helicopter or by truck with an insulating crane. However, the costs and constraints on access through these solutions significantly lessen the advantages of having a tele-controlled robot. In other words, once the difficulty of getting one or more electricians up to the live conductor has been dealt with, they can carry out several inspection tasks. Even for inspections where the use of a tele-controlled robot is required, the cost of its installation and removal from the conductor undermines the feasibility of using this technique on a large scale.

As demonstrated, there are clear advantages in developing a robot that could be installed on the conductor from the pylon, using an insulating rod for this purpose. This invention shows how this technique was successfully implemented on a tele-controlled robot used for corrosion inspections on steel-core aluminum conductors (SCC). Several aspects of the robot are fundamental for allowing this type of installation, such as its shape, the guide system for fitting it onto the conductor, light weight so it can be supported by the rod, adjustment of its centre of gravity in order to maintain stability and the design of the sensor that automatically clips onto the conductor. These aspects are described in this document and constitute the main claims of this invention.

### DESCRIPTION OF THE STATE OF THE ART

There are several types of power line inspection robots on the market. In general, these devices may be classified into three categories. The first consists of flying robots, which may be in the shape of tele-controlled aircraft or helicopters carrying video cameras and flying along the monitored power line [2]-[3].

The second category consists of manually operated robots [4]-[5]. These are not actually robots, but are rather tele-controlled inspection devices that require an operator in order to travel along the conductor. One of these robots is the manually operated robot made by Fujikura [4] which is conducted along a power line by the operator (see FIG. 1 of the drawings).

More common, the third category consists of crawler robots that move along the conductor being inspected [6]-[16]. One of these robots is the crawler robot made by Kinectrics [16] that is installed on the conductor by a truck with an insulating crane (see FIG. 2 of the drawings).

### PURPOSE OF THE INVENTION

An electro-mechanical design for a live power line cable inspection robot that can be installed on the cable from the pylon, using an insulating rod.

### BRIEF DESCRIPTION OF THE DRAWINGS

FIG. 1 is a photograph showing the installation of a manually operated robot made by Fujikura.

FIG. 2 is a photograph showing the installation of a crawler robot made by Kinectrics.

FIG. 3A is a perspective view of the robot addressed by this invention, shown with its cowling, installed on the transmission line conductor.

FIG. 3B is a front view of the robot addressed by this invention, shown with its cowling, installed on the transmission line conductor.

FIG. 4 is a perspective view of the robot addressed by this invention, shown without its cowling, being steered by the guide rollers towards the transmission line conductor.

FIG. 5 is a perspective view of the robot addressed by this invention, shown without its cowling, being fitted on to the transmission line conductor.

FIG. 6 is a perspective view of the robot addressed by this invention, shown without its cowling, supported on the transmission line conductor and closing the sensor.

FIG. 7 is a perspective view of the robot addressed by this invention, shown without its cowling, supported on the transmission line conductor with the sensor closed.

FIGS. 8A and 8B are a front view and a perspective view, respectively, of the guide rollers for positioning the robot addressed by this invention on a transmission line conductor.

FIGS. 9A and 9B are front views of the opening and closing mechanism of the sensor by traction on the eyebolt, in the closed position and the open position of the above-mentioned mechanism, respectively.

FIG. 10 is a photograph showing the robot addressed by this invention being hoisted up the pylon on a rope.

FIG. 11 is a photograph showing the installation of a robot on a live power line conductor, using an insulating rod.

### DISCUSSION OF THE INVENTION

Constraints of Products Currently Available on the Market

The most obvious disadvantage of flying robots is the risk of a defect in the robot damaging the supervised line, in addition to other consequences (meaning the robot could fall on inhabited areas). Another disadvantage is that this type of inspection is limited to visual inspections or those using thermographic imaging, as a sensor cannot be coupled to the conductor.

The clear disadvantage of manually operated robots is the need for the operator to accompany the robot during inspections. In addition to the risks of industrial accidents inherent to this activity, the weight of the operator prevents such inspections from being conducted on lines whose conductors are installed vertically.

Crawler robots do not present the disadvantages of flying robots, but they can conduct accurate inspections of conductors only when their support is ensured by such conductors. Similarly, crawler robots do not require an operator to accompany the robot, as is the case with manually operated robots. However, crawler robots offer the disadvantages of having to be installed on the conductor, with difficulties in getting past obstacles (such as splices in the conductor and clamps holding it to the pylon).

In general, the physical aspects of manually operated and crawler robots (such as weight, manner of installation, slotting in the sensor) require installation on conductors by one or more electricians (see FIG. 2 of the drawings). Should the installation be on a live power line, installing the robot on the conductor requires the use of a helicopter or a truck with an insulating crane, significantly increasing the costs of an inspection.

Causes of the Constraints of Products Currently Available on the Market

The main problems associated with flying and manually operated robots are inherent to their conceptualizations, while the problems associated with crawler robots are related to design aspects. On the other hand, difficulties in getting past obstacles is related to the electro-mechanical design of crawler robots. In fact, as shown by the references [6]-[12], a series of steps may be used that allow a crawler robot to get past obstacles along the length of the conductor.

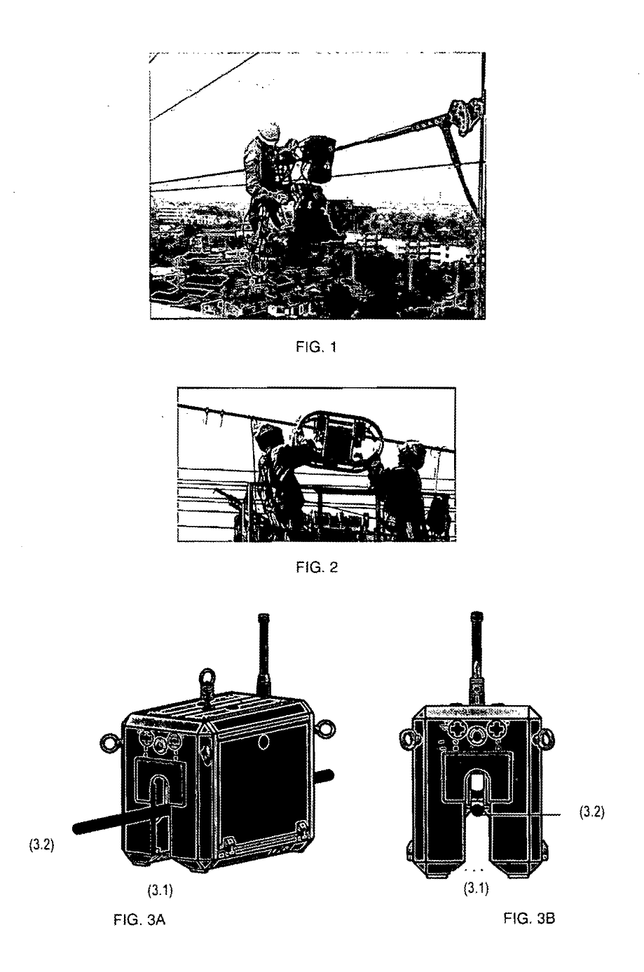

Similarly, difficulties in installing the robot on the conductor by a rod are also related to its electro-mechanical design. The main causes of this problem are:
Weight of the robot: In order to install robot on a conductor using a rod, it must be light enough for the electrician to support it manually. For example, the Hydro Québec crawler robot [15] weighs 112 kg, which cannot be supported by a rod. Similarly, the Fujikura crawler robot [11] weighs 70 kg, which also prevents handling it by a rod. The Kinectrics crawler robot [16] shown in FIG. 2 weighs 35 kg, constituting a development in this product (whose previous version weighed 50 kg), but is still very heavy for a rod installation.
   Slotting onto the conductor: crawler robots are normally placed on the conductor from the side, where a slot along one side of the robot allows it to be fitted onto the conductor (see FIGS. 1 and 2). This type of connection requires the presence of one (or two) electricians in order to guide the conductor along the side slot.
Adjustment of the centre of gravity: For installation on the conductor using a rod, the robot must be hoisted by a single eyebolt installed in a position that coincides with the vertical alignment of its centre of gravity. The current robots make no provision for this type of hoisting operation. Furthermore, the centre of gravity must be adjusted in a manner that assures the stability of the robot while being moved into place.
Closing the sensor: For the crawler robots that are currently available on the market, closing the sensor around the conductor is also a task that requires the presence of an operator. As a general rule, the conductor must be fitted into the sensor, which is then closed, using ancillary locking pulleys. For a rod installation, the sensor would have to close automatically.

Technical, Commercial and Economic Advantages of the Invention

The main technical advantage of installing the robot by a rod is the possibility of inspecting conductors on spans of lines that are not accessible through the current inspection robot installation methods. For example, there are many spans of power lines in mountainous areas that are not accessible for trucks with insulating cranes used to install inspection robots. Similarly, line conductors installed in power line corridors (several power lines in parallel) are not accessible by helicopter.

The main commercial advantage is a significant reduction in inspection costs, as the installation of a robot using a rod requires only a small live line team travelling in a regular vehicle owned by the concessionaire. Final access to the foot of the pylon can be achieved through any available means, including by foot.

Finally, the economic advantage is reflected in the benefits arising from the inspection conducted. For an inspection designed to assess the remaining useful life of the conductor, the economic benefits consist of lower power line maintenance costs (OPEX) and avoidance of outlays arising from falling conductors (fine, loss of profits and emergency repair costs).

### DETAILED DESCRIPTION OF THE INVENTION

The crawler robot addressed by this paper was developed for inspecting live power lines, based on the assumption that it would be installed on the conductor by an insulating rod. To do so, the following steps were taken:

Weight Reduction

Several techniques were used to lower the weight of the robot, such as using aluminum to make most of its parts, for example, as this is some three times less dense than steel. The mechanical devices on the robot were also made more compact, in order to reduce its size and consequently its weight. The final dimensions of the robot are: width 27 cm×length 45 cm×height 36 cm, weighing 16 kg

Slotting onto the Conductor¶

In contrast to other crawler robots that fit on to the conductor along the side, the robot addressed by this invention is slotted onto the conductor vertically, similar to the manner in which a saddle is placed on a horse.

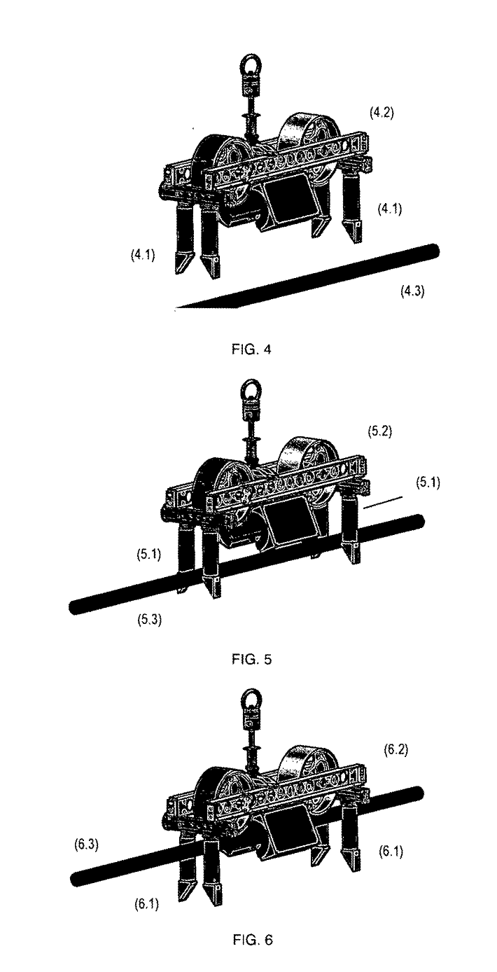

FIGS. 3A and 3B show the shape of the robot that allows this type of installation. Note that the lower part of the robot has a longitudinal opening (3.1) in the cowling structure that allows the robot to slot onto the conductor (3.2). The V-shape of the structure is the conductor towards the opening in the cowling. Once in the cowling, a pair of guide rollers on each side of the robot guides the conductor into its position alongside the pulleys that support its weight and ensure its movement. FIGS. 4, 5, 6 and 7 show an internal perspective of the robot without the cowling, shown in FIGS. 3A and 3B, where the guide rollers (4.1; 5.1; 6.1; 7.1) are visible, which also perform an important function of electrically connecting the robot structure (4.2; 5.2; 6.2; 7.2) to the conductor (4.3; 5.3; 6.3; 7.3), in order to avoid sparks.

The roller guide mechanism is shown in 8A and 8B, where the worm thread axis (8.1) may be seen, together with the springs that press the roller guides against the conductor (8.2). Each roller guide has ball bearings (8.3) installed along its central axis, allowing it to spin freely as the robot moves along the conductor.

The gap between the roller guides is adjusted previously by a disc (8.4) that triggers a worm thread mechanism, in order to size its opening to the gauge of the conductor that will be inspected. This adjustment system is fitted with springs that press the roller guides against the conductor. At the same time as this keeps the robot aligned on the conductor, these springs endow the roller guides with sufficient flexibility to adapt to minor local variations in the diameter of the conductor.

Adjustment of the Centre of Gravity

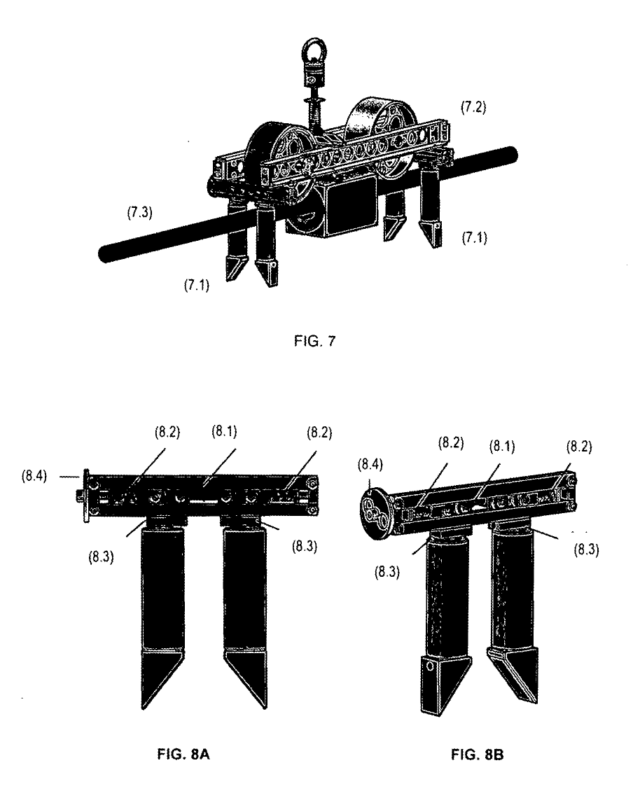

The robot design follows a plan based on vertical symmetry, with the centre of gravity of the robot located above the conductor axis. To do so, asymmetrical components such as the motor and electronic circuit were arrayed on opposite sides, in order to preserve an even balance. The robot is powered by two batteries installed in its lower section (one on each side) in order to lower its centre of gravity. Furthermore, fine-tuning battery positions allows the robot to be balanced evenly, ensuring that its centre of gravity coincides with the axis of the conductor. In other words, adjusting the position of the batteries offsets the differences between the asymmetrical components and allows the centre of gravity of the robot to be outlined with the axis of the conductor. FIG. 7 shows the robot addressed by this invention (shown without its cowling, for clarity) installed on a conductor.

As shown in FIGS. 4 to 7, the robot has the central eyebolt (9.1) for use during hoisting. This eyebolt is located over the centre of gravity of the robot, ensuring that it is requested horizontally and can be mounted on the conductor using a rod.

Opening and Closing the Sensor

In order to ensure that the robot can be installed through the use of a rod, it is important that the sensor closes automatically over the conductor. To do so, a mechanism is coupled to the hoisting eyebolt, in a manner whereby the sensor opens to receive the conductor when this eyebolt is pulled. When the robot is supported by the conductor and the eyebolt loosens, a spring pushes the sense or into its closing position.

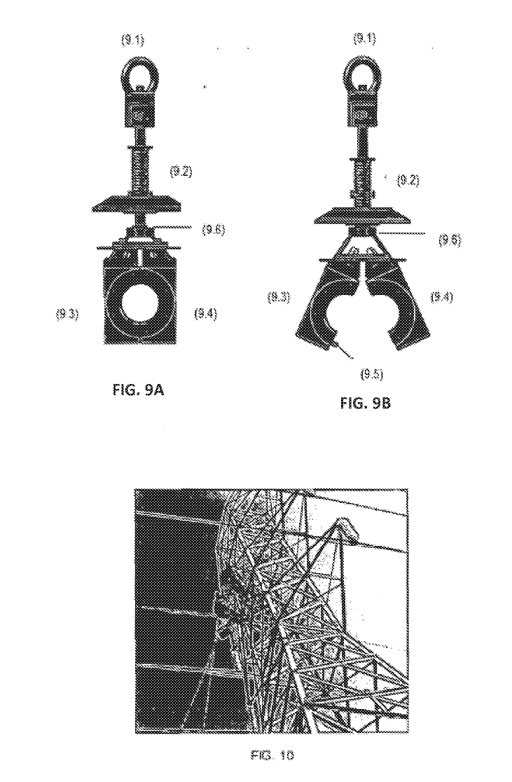

FIGS. 9A and 9B show the opening and closing mechanism of the sensor. In FIG. 9A, the sensor is in repose, meaning that the hoisting eyebolt (9.1) is not under traction. In this condition, its weight works with the strength of the spring (9.2) to ensure that the two halves of the sensor (9.3 and 9.4) meet. In this position, the conductor to be inspected will be located within the orifice formed by the two halves of the sensor. A buffer (9.5) installed on the sensor indicates that it is correctly closed and ready to operate. When placing traction on the eyebolt (9.1), the spring (9.2) is compressed and a mechanism (9.6) forces the two halves of the sensor apart, as shown in FIG. 9B. Consequently, while the robot is being raised by the insulating rod for placement on the conductor, the sensor remains open and allows the conductor to run through it. When supported by the conductor, the stencil closes automatically over it, allowing the inspection to be conducted.

Example of a Robot Installation Using a Rod

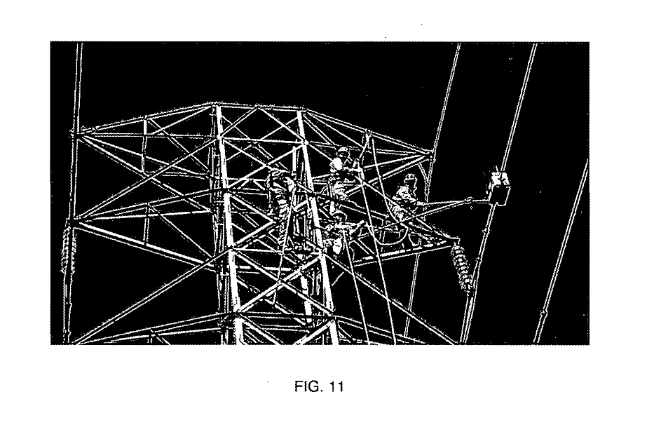

Once the robot is ready to be installed on the power line by a rod, several techniques can be developed by the concessionaire for its installation. For example, the robot can be hoisted to the top of the pylon by a rope tied to its central eyebolt, as shown in FIG. 10. At the top of the pylon, an electrician fixes the robot to the end of an insulating rod with a hook and carries the robot over to the conductor. Another electrician uses one of the side eyebolts to guide the robot into its installation position, using another rod. Once in position, the robot is supported on the cable, as shown in FIG. 11. The electrician then disconnects the hook from the robot and releases it for remote control through the radio system.

### REFERENCES

[1] C. F. Barossa, F. E. Nolin, P. C. Gasoline e C. Aoki, “Sensor e system Para detector ad corrosion me camera de zinc sober ace,” Patent of Innovation, Registration No P1 0705769-5 A2, filing date: Jun. 8, 2007:
[2] EP2495166 (A1), “Aerial robotic system for the inspection of overhead power lines”.
[3] R. K. Rangel, K. H. Kienitz, M. P. Brandao, “System de inspeção de linhas de transmissao de energia eletrica utilizando velculos aereos nao tripulados”, 2009 Brazilian Symposium on Aerospace Engineering & Applications, Sao Jose dos Campos, September 2009.
[4] “Diagnosis of internal corrosion technology for ACSR conductor of overhead power lines”, Fujikura News No 372, July 2012.
[5] Intron, “Non destructive testing and technical diagnostics”, available at: www.intron-plus.com, accessed on: 28, Aug. 2013.
[6] WO2011081274 (A1), “Line inspection robot and system”.
[7] WO2011081274 (A1), “Robot for inspecting a power distribution line”.
[8] WO2009058041 (A2), “Robot capable of moving hanging in suspended lines”.
[9] WO2006085804 (A1), “Line inspection”.
[1] CA2418473 (A1), “Robot vehicle that runs on conductors and has the ability to negotiate obstacles using temporary support rotors”.
[11] JPH02136005 (A), “Abnormality detection and inspection robot for aerial cable”.
[12] US2006150857 (A1), “Remote controlled vehicle which travels on conductor and which can pass over obstacles by means of temporary support rotors”.
[13] US2011196536 (A1), “Line inspection robot and system.
[14] ZA200205888 (A), “Remote operated trolley for inspection and intervention for a live electrical power grid in operation and ice removing equipment”.
[15] US2008276823 (A1), Remote-controlled vehicle designed to be mounted on a support and capable of clearing an obstacle”.
[16] “LineVue: Advanced nondestructive technology for accurate conductor 30assessment”, Kinectrics, 23 Sep. 2010, available at: www.kinectrics.com, accessed on: 28, Aug. 2013.

1. Robot for the inspection of live transmission line cables, comprised by the fact that it encompasses:
on the lower part of the robot, a longitudinal opening (3.1) in the cowling structure which allows the robot to fit onto the conductor (3.2);
a pair of guide rollers (4.1; 5.1; 6.1; 7.1) on each side of the robot in order to guide the conductor (3.2) into its correct position next to the police that support its weight and ensure its movement;
a worm thread axis (8.1) and springs that press the guide rollers (4.1; 5.1; ten 6.1; 7.1) against the conductor (4.3); where the gap between such guide rollers is adjusted previously through a disc (8.4) that triggers a worm thread mechanism, in order to ensure that its opening is compatible with the gauge of the conductor that will be inspected; and
a mechanism coupled to the hoisting eyebolt (9.1) whereby when the said eyebolt is pulled, a sensor split into two halves (9.3 and 9.4) opens to receive such conductor and when the robot is supported on such conductor and the hoisting eyebolt is loosened (9.1), the spring (9.2) forces the sensor split into two halves (9.3 and 9.4) into its closed position.

2. Robot, as set forth in claim 1, comprised by the fact that the cowling structure is V-shaped in order to guide the conductor towards the opening in the cowling.

3. Robot, as set forth in claim 1, comprised by the fact that the guide rollers (4.1; 5.1; 6.1; 7.1) also have the important function of linking the robot structure to the conductor electrically, in order to avoid sparks.

4. Robot, as set forth in claim 1, comprised by the fact that the guide rollers (4.1; 5.1; 6.1; 7.1) have ball bearings installed in their central axis.
